(19) United States
(12) Patent Application Publication
(10) Pub. No.: US 2015/0251258 A1
(43) Pub. Date: Sep. 10, 2015

(54) Brush-less Chainsaw

(71) Applicant: CHANGZHOU GLOBE CO., LTD., Changzhou (CN)

(72) Inventors: Tengyun Jiang, Changzhou (CN); Yin Chen, Changzhou (CN); Jianbo Tian, Changzhou (CN); Hairong Chen, Changzhou (CN); Biao Li, Changzhou (CN)

(73) Assignee: CHANGZHOU GLOBE CO., LTD.

(21) Appl. No.: 14/718,070

(22) Filed: May 20, 2015

Related U.S. Application Data
(63) Continuation of application No. PCT/CN2013/001377, filed on Nov. 13, 2013.

(30) Foreign Application Priority Data
Dec. 3, 2012 (CN) 201210506084.7

(51) Int. Cl. B23D 57/02

(52) U.S. Cl. CPC B23D 57/023

(57) ABSTRACT

A brush-less chainsaw is disclosed, comprising a housing, a brush-less motor, a transmission device, a power supply, an electronic commutator, a brake backplate, a chain plate, and a chain. The brush-less motor, the transmission device, and the electronic commutator are disposed in the housing. The brush-less motor is connected with the electronic commutator. A power output end of the brush-less motor is connected with the transmission device. The electronic commutator detects a position signal of the brush-less motor and controls the brush-less motor to drive the chain and the chain plate to rotate. The electronic commutator receives a brake signal from the brake backplate and transmits the signal to the brush-less motor. The brush-less motor drives the chain to brake according to the brake signal. The brush-less chainsaw has the advantage of optimizing the performance, along with small size, low cost, large torque, and small braking current.

### CROSS REFERENCE TO RELATED APPLICATIONS

The present application is a Continuation Application of PCT application No. PCT/CN2013/001377 filed on Nov. 13, 2013, which claims the benefit of Chinese Patent Application No. 201210506084.7 filed on Dec. 3, 2012. All the above are hereby incorporated by reference.

### BACKGROUND OF THE INVENTION

1. Technical Field

The present invention relates to a brush-less chainsaw, in particular to a brush-less chainsaw for gardening tools and electric tools.

2. Description of Related Art

A chainsaw is a traditional electric cutting tool, usually used to trim or cut plants. Generally, the motor of the chainsaw drives the chain to perform cutting.

At present, most of the tool products in the market have the brushed motor drive, with the defects of limited service life of the carbon brush, low efficiency (generally about 50%), and because of load and other factors, about 30˜200 Hr service life.

Even if the motors of the some products are provided with replaceable carbon brushes to prolong the service life, but, due to the limited service life of the commutator, the carbon brush is useless as long as the motor is replaced once because of expiration of the service life.

Besides, the tool products produced by some manufacturers are directly driven by brush-less motors, solving the problem of the service life of the brushed chainsaw. But, the driving tool has a relatively large working torque, and it is needed to greatly increase the motor size to obtain a large torque when the motor performs direct drive, so the defects such as high cost, large weight and large reverse kinetic potential of the brake are generated.

Traditional mechanical brake devices have complicated structures, are easily worn to lose efficiency after service for a long time, tend to reduce the braking effect, and have high subsequent maintenance cost.

### SUMMARY OF THE INVENTION

The present invention mainly solves the technical problem of providing a brush-less chainsaw. The brush-less chainsaw utilizes the energy consumption mode of the motor coils to realize the quick stopping of the motor, and the brush-less chainsaw takes advantage of high efficiency and long service life of the brush-less motor and uses a deceleration device to increase the output torque, thus achieving small size, low cost, large torque, and small braking current and optimizing the performance of the brush-less chainsaw.

To solve the above technical problems, the present invention employs the following technical solution: A brush-less chainsaw comprises a housing, a brush-less motor, a transmission device, a power supply, an electronic commutator, a brake backplate, a chain plate, and a chain; the brush-less motor, the transmission device, and the electronic commutator are disposed in the housing; the brush-less motor is connected with the electronic commutator; and a power output end of the brush-less motor is connected with the transmission device.

In a preferable embodiment of the present invention, the transmission device comprises a transmission body, an output shaft assembly, a gearbox cover and a chain wheel; the transmission body is fixedly connected to the power output end of the brush-less motor; the output shaft assembly is fixedly disposed in a hole in the transmission body; the gearbox cover is installed on the transmission body; the output end of the brush-less motor is connected with the output shaft assembly through a gear; and the output shaft assembly drives the chain wheel so as to drive the chain to rotate.

In a preferable embodiment of the present invention, the tooth profile of the gear is an involute profile or circular arc.

In a preferable embodiment of the present invention, the transmission device is a single-speed change structure, a multi-speed change structure, or a step-less speed change structure.

In a preferable embodiment of the present invention, the gear comprises a driving wheel and a driven wheel; when the size of the driving wheel is smaller than that of the driven wheel, the deceleration function can be conducted; when the size of the driving wheel is larger than that of the driven wheel, the acceleration function can be conducted.

In a preferable embodiment of the present invention, the housing is internally provided with an oil pump and an oil kettle; one end of the oil pump is connected to the transmission device, and the other end is connected with the oil kettle.

In a preferable embodiment of the present invention, the housing is connected with an alarm display device; the alarm display device is connected with the brush-less motor, the transmission device and the electronic commutator.

In a preferable embodiment of the present invention, the housing is connected with a switch trigger, a main switch, a first microswitch, a second microswitch, a brake backplate and a lighting switch; the switch trigger is linked with the main switch; the first microswitch and the second microswitch are linked with the brake backplate; the main switch, the first microswitch, the second microswitch and the lighting switch are all connected to the electronic commutator.

In a preferable embodiment of the present invention, the electronic commutator is also connected with the input end of the power supply, and the power supply mode of the electronic commutator is DC input or AC input.

In a preferable embodiment of the present invention, the power supply is a DC power supply; the input end of the power supply is connected with a detachable DC power supplier, a detachable portable battery pack or AC/DC transformer; the power supply is an AC power supply, and the input end of the power supply is connected to the mains supply.

In a preferable embodiment of the present invention, the housing is also provided with a main air inlet and an air outlet; the housing is internally provided with an air baffle; the dissipating plane of the electronic commutator is disposed behind the main air inlet or in front of the air outlet such that the air flow generated by rotation of the brush-less motor passes through the dissipating plane of the electronic commutator to bring the heat away.

The present invention has the beneficial effects that: the brush-less chainsaw of the present invention can utilize the energy consumption mode of the motor coils to realize the quick stopping of the motor, thus obviously reducing the cost and overall weight; and the brush-less chainsaw take advantage of high efficiency and long service life of the brush-less motor and uses a deceleration device to increase the output torque, thus achieving small size, low cost, a large torque and small braking current and optimizing the performance of the brush-less chainsaw.

### BRIEF DESCRIPTION OF THE DRAWINGS

FIG. 1 is an exploded view of the brush-less chainsaw in one embodiment of the present invention.

FIG. 2 is a structural view of the brush-less motor and transmission device in the brush-less chainsaw of the present invention.

FIG. 3 is a main view of the brush-less chainsaw of the present invention.

FIG. 4 is a control schematic view of the control process of the brush-less chainsaw of the present invention.

FIG. 5 is a main view of the dissipating air path of the brush-less chainsaw of the present invention.

FIG. 6 is a vertical view of the dissipating air path of the brush-less chainsaw of the present invention.

Marks of parts in the figures are as follows: 1. first microswitch, 2. electronic commutator, 3. brake backplate, 4. housing, 5. transmission device, 6. chain, 7. lateral cover tightening member, 8. power supply, 9. switch trigger, 10. main switch, 11, oil kettle, 12. brush-less motor, 14. oil pump, 15. transmission body, 16. output shaft assembly, 17. gearbox cover, 18. chain wheel, 19. alarm display device, 20. second microswitch, 21. lighting switch, 22. air inlet, 23. air outlet, 24. air baffle, 25. driving wheel, 26. driven wheel, 27. chain plate.

### DETAILED DESCRIPTION OF THE INVENTION

The preferable embodiments are described in detail with reference to the attached drawings such that those skilled in this field can more easily understand the advantages and characteristics of the present invention to more clearly define the protective scope of the present invention.

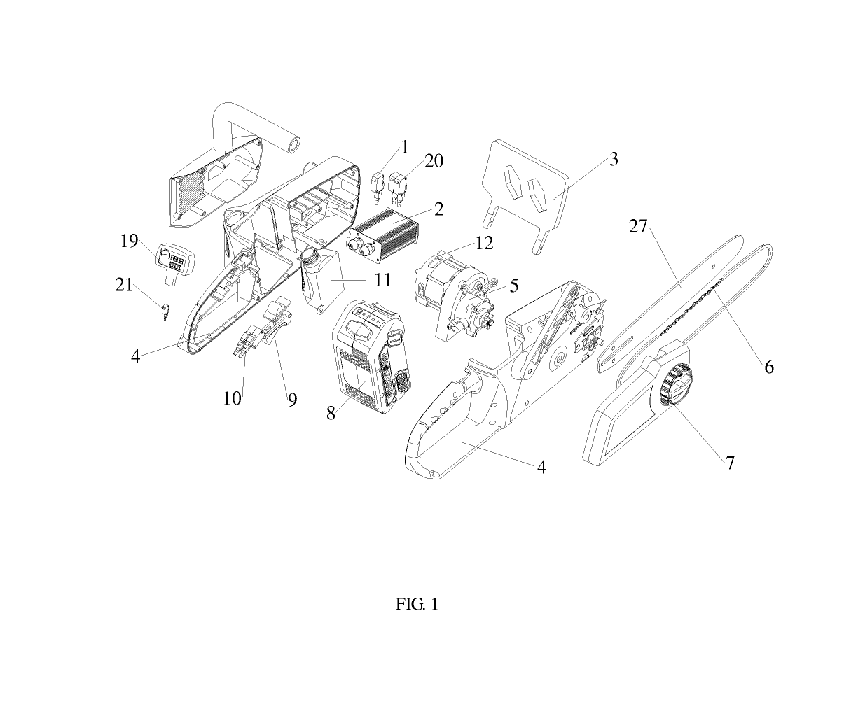

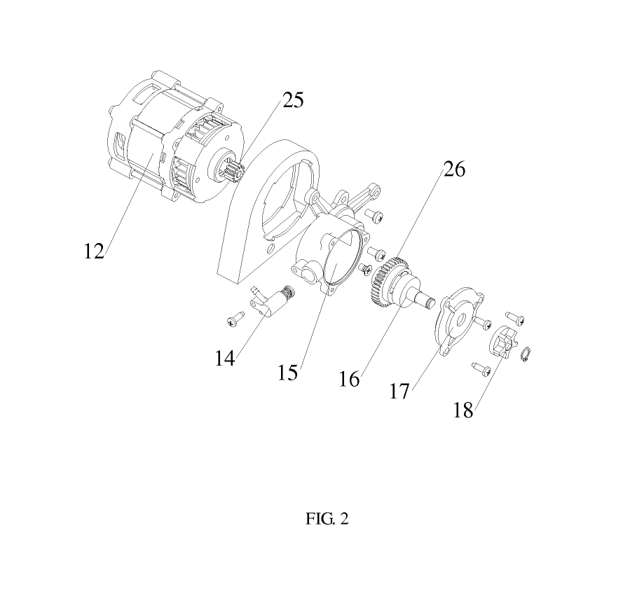

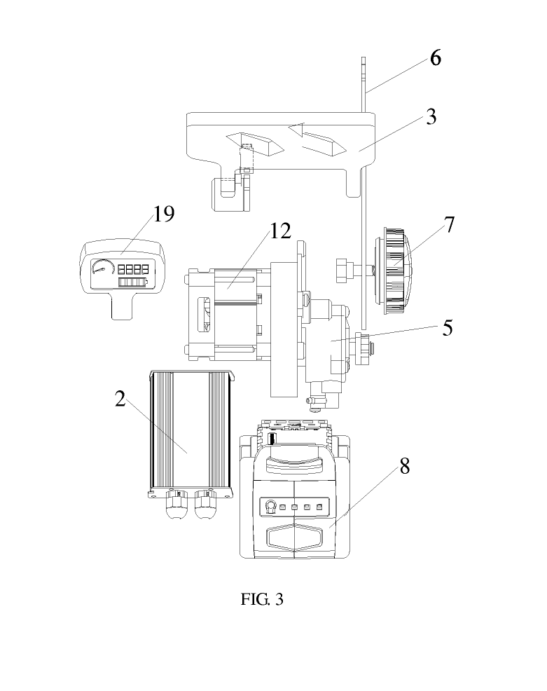

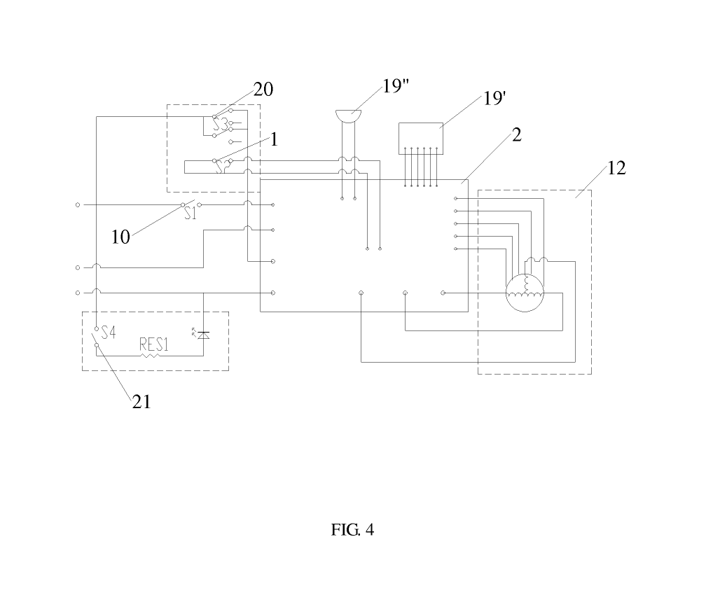

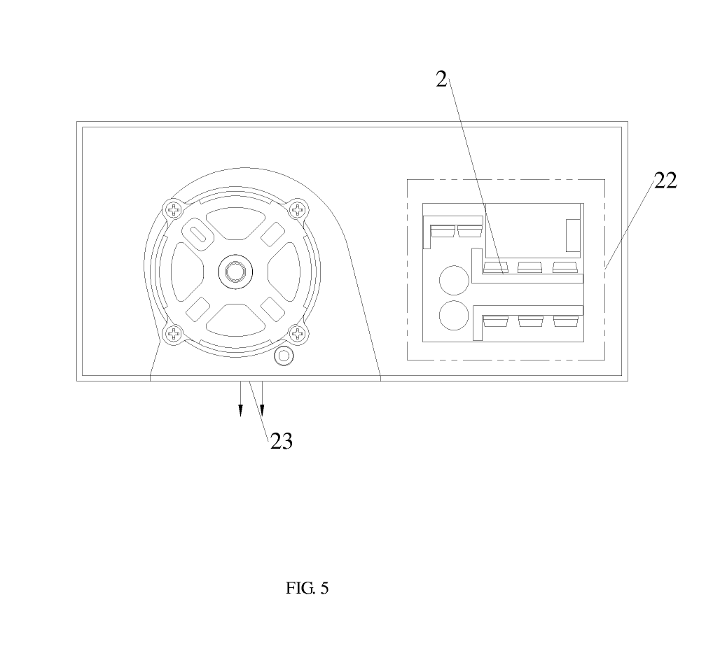

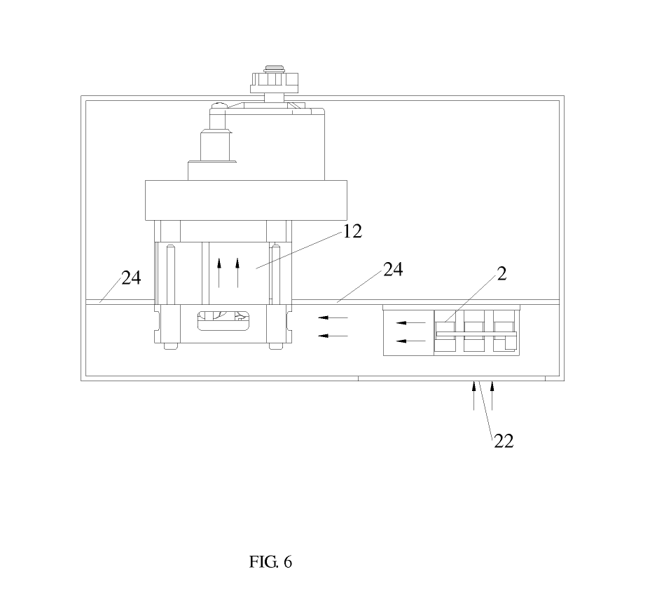

Refer to FIGS. 1-6. An embodiment of the present invention includes:

A brush-less chainsaw comprises a housing 4, a brush-less motor 12, a transmission device 5, an electronic commutator 2, a chain 6, and a chain plate 27. The brush-less motor 12, the transmission device 5, and the electronic commutator 2 are disposed in the housing 25. The brush-less motor 12 is connected with the electronic commutator 2. The power output end of the brush-less motor 12 is connected with the transmission device.

In the present invention, the transmission device 5 comprises the brush-less motor 12, a transmission body 15, an output shaft assembly 16, a gearbox cover 17 and a chain wheel 18.

The transmission body 15 is fixedly connected to the power output end of the brush-less motor 12. The output shaft assembly 16 is fixedly disposed in a hole in the transmission body 15. The gearbox cover 17 is installed on the transmission body 15. The output end of the brush-less motor 12 is connected with the output shaft assembly 16 through a gear. The output shaft assembly 16 is linked with the chain 6 through the chain wheel 18.

Wherein, the tooth profile of the transmission device 5 may be an involute profile or circular arc. The involute teeth may be straight teeth, helical teeth or bevel teeth. The transmission device 5 may be a single-speed change structure, a multi-speed change structure or a step-less speed change structure, confirmed according to the size of the output torque. When the size of the driving wheel 25 is smaller than that of the driven wheel 26, the deceleration function can be conducted; on the contrary, and when the size of the driving wheel 25 is larger than that of the driven wheel 26, the acceleration function can be conducted.

The housing 4 is connected with an alarm display device 19; the alarm display device 19 is connected with the brush-less motor 12, the transmission device 5, and the electronic commutator 2.

Specifically, the alarm display device 19 may have the display function or alarm function only or have the display and alarm functions, and the fed function may be the working state of all parts of the whole brush-less chainsaw, or the remaining time that the brush-less chainsaw can work.

The housing 4 is also connected with a switch trigger 9, a main switch 10, a first microswitch 1, a second microswitch 20, a brake backplate 3 and a lighting switch 21.

The switch trigger 9 is linked with the main switch 10. The first microswitch 1 and the second microswitch 20 are linked with the brake backplate 3, which means that the first microswitch 1 and the second microswitch 20 are driven by the brake backplate 3 to switch on or off.

The main switch 10, the first microswitch 1, the second microswitch 20 and the lighting switch 21 all are connected to the electronic commutator 2.

The housing 4 is also connected with a lateral cover tightening member 7 which fixes the chain 6 at a position with a proper degree of tightness. The chain 6 is driven by the speed governor of the brush-less motor to perform cutting.

The housing 4 is internally provided with a power supply 8. The power supply 8 is connected with the electronic commutator 2. The power supply 8 is a DC power supply or an AC power supply, which can be configured upon needs.

When the power supply 8 is a DC power supply; the input end of the power supply 8 is connected with a detachable DC power supplier, a detachable portable battery pack or AC/DC transformer; when the power supply 8 is an AC power supply, and the input end of the power supply 8 is connected to the mains supply.

The housing 4 is internally provided with an oil pump 14 and an oil kettle 11; one end of the oil pump 14 is connected to the transmission device 5 and the other end is connected with the oil kettle 11.

In the present invention, the power supply mode of the electronic commutator 2 is DC power input or AC power input.

To reduce the axial length of the brush-less motor 12 and better utilize the inner space of the housing 4 of the chainsaw, in the present invention, the dissipating plane of the electronic commutator 2 is disposed behind the main air inlet or in front of the air outlet such that the air flow generated by the rotation of the brush-less motor 12 passes through the dissipating plane of the electronic commutator 2 to bring the heat away.

The dissipating plane of the electronic commutator 2 is disposed behind the main air inlet 22; the air inlet of the brush-less motor 12 is not provided with the main air inlet 22; the housing is internally provided with an air baffle 24 to enclose the brush-less motor 12 and the electronic commutator 2 in a relatively small space (this space has the air input only at the position of the main air inlet 22).

During working, cooling fans of the brush-less motor rotate to form negative pressure, and the cooling air goes in from the main air inlet 22, passes through the cooling surface of the electronic commutator 2 to bring away the heat, then enters the air inlet of the motor to take away the heat in the brush-less motor 12, and finally is discharged from the air outlet 23.

The control process of the brush-less chainsaw of the present invention comprises the following steps:

a. Start control step

Start function: when the main switch 10 is closed, the electronic commutator 2 detects the position signal of a hall sensor on the brush-less motor 12 and gives a corresponding control signal to control current to pass through the three-phase coil on the brush-less motor 12 in turn, thus realizing the efficiency rotation of the brush-less motor 12 and driving the chain 6 to rotate to fulfill the aim of cutting; and when the main switch 10 is released, the brush-less motor 12 can slow down freely.

b. Brake control step

The brake backplate 3 rotates to transmit the brake signal to the electronic commutator 2, and the microswitch 20 cuts off the power supply 8 of the brush-less motor 12 at the same time; the electronic commutator 2 short-circuits the coil of the brush-less motor 12 to realize the quick stopping of the brush-less motor 12, and the alarm display device 19 sounds or displays an alarm to the client.

The braking mode provided in the present invention utilizes the energy consumption mode of the coil of the brush-less motor 12 to realize the quick stopping of the motor, and the typical braking time is smaller than 0.15 s.

This means that the coil of the brush-less motor 12 is utilized to generate the braking effect, and the braking effect can be achieved by only providing the electronic commutator 2 with a brake signal, while the cost and weight of the whole chainsaw will be lowered obviously.

The control process of the present invention also comprises an alarm display process and a protection process.

In the alarm display process, the whole brush-less chain's real-time working state can be displayed through the electronic commutator 2 and the alarm display device 19, for example, the real-time electric quantity, real-time working current, real-time saw temperature, real-time line-cutting speed, braking state prompt function, etc.

In the protection process, the power supply 8 and the electronic commutator 2 of the entire system can identify communication, and the battery discharge is integrated in the brush-less control system; when the battery is over-charged or over-current, or over-hot, the system connection is cut off to protect the battery system.

The power supply 8 and the electronic commutator 2 of the entire system can identify the communication, and the electronic commutator 2 can automatically control the adjustable output of the load and reduce the useless output of empty load to prolong the service life of the battery and fulfill the energy-saving purpose of the whole chainsaw.

The brush-less chainsaw of the present invention has the beneficial effects of:

utilizing the energy consumption mode of the motor coil to realize quick stopping of the motor, namely generating the braking effect to the motor coil simply by providing the control system with a brake signal, the cost and weight of the whole chainsaw will be lowered obviously;

taking advantage of high efficiency (generally over 80%) and long service life of the brush-less motor and using the deceleration device to increase the output torque, small size, low cost, large torque and small braking current are achieved and the performance of the whole chainsaw is optimized.

The above are only some embodiments of the present invention and shall not be regarded as limit to the present invention. Any equivalent structure or equivalent flow modifications made on the basis of the description and attached drawings of the present invention, or director or indirect application to other related fields, shall fall within the protective scope of the present invention.

What is claimed is:

1. A brush-less chainsaw, comprising a housing, a brush-less motor, a transmission device, a power supply, an electronic commutator, a brake backplate, a chain plate, and a chain; the brush-less motor, the transmission device, and the electronic commutator being disposed in the housing; characterized in that, the brush-less motor is connected with the electronic commutator; and a power output end of the brush-less motor is connected with the transmission device.

2. The brush-less chainsaw according to claim 1, characterized in that, the transmission device comprises a transmission body, an output shaft assembly, a gearbox cover, and a chain wheel; the transmission body is fixedly connected to the power output end of the brush-less motor; the output shaft assembly is fixedly disposed in a hole in the transmission body; the gearbox cover is installed on the transmission body; the output end of the brush-less motor is connected with the output shaft assembly through a gear; and the output shaft assembly drives the chain wheel so as to drive the chain to rotate.

3. The brush-less chainsaw according to claim 2, characterized in that, the tooth profile of the gear is an involute profile or circular arc.

4. The brush-less chainsaw according to claim 2, characterized in that, the transmission device is a single-speed change structure, a multi-speed change structure, or a step-less speed change structure.

5. The brush-less chainsaw according to claim 2, characterized in that, the gear comprises a driving wheel and a driven wheel; when the size of the driving wheel is smaller than that of the driven wheel, the transmission device conducts the deceleration function; when the size of the driving wheel is larger than that of the driven wheel, the transmission device conducts the acceleration function.

6. The brush-less chainsaw according to claim 1, characterized in that, the housing is internally provided with an oil pump and an oil kettle; one end of the oil pump is connected to the transmission device, and the other end is connected with the oil kettle.

7. The brush-less chainsaw according to claim 1, characterized in that, the housing is connected with an alarm display device; the alarm display device is connected with the brush-less motor, the transmission device, and the electronic commutator.

8. The brush-less chainsaw according to claim 7, characterized in that, the housing is connected with a switch trigger, a main switch, a first microswitch, a second microswitch, a brake backplate and a lighting switch; the switch trigger is linked with the main switch; the first microswitch and the second microswitch are linked with the brake backplate; the main switch, the first microswitch, the second microswitch, and the lighting switch are all connected to the electronic commutator.

9. The brush-less chainsaw according to claim 1, characterized in that, the electronic commutator is also connected with the input end of the power supply, and the power supply mode of the electronic commutator is DC input or AC input.

10. The brush-less chainsaw according to claim 9, characterized in that, the power supply is a DC power supply; the input end of the power supply is connected with a detachable DC power supplier, a detachable portable battery pack or AC/DC transformer; the power supply is an AC power supply, and the input end of the power supply is connected to the mains supply.

11. The brush-less chainsaw according to claim 1, characterized in that, the housing is also provided with a main air inlet and an air outlet; the housing is internally provided with an air baffle; the dissipating plane of the electronic commutator is disposed behind the main air inlet or in front of the air outlet such that the air flow generated by rotation of the brush-less motor passes through the dissipating plane of the electronic commutator to bring the heat away.
